(19) United States
(12) Patent Application Publication
(10) Pub. No.: US 2007/0068348 A1
(43) Pub. Date: Mar. 29, 2007

(54) UNIVERSAL KEY

(76) Inventor: Hermann Schunke, Hilchenbach (DE)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/534,386

(22) Filed: Sep. 22, 2006

(30) Foreign Application Priority Data
Sep. 22, 2005 (DE) 10 2005 045 282.5

(51) Int. Cl. B25B 23/00; B25B 13/00; B25G 1/08; B25B 23/16

(52) U.S. Cl. 81/177.4; 81/124.5; 81/439

(57) ABSTRACT

The invention relates to a universal key (1), particularly a control cabinet key, with multiple key arms (2a, 2b, 2c, 2d), on which tool heads (12a, 12b, 13a, 13b) and/or retainers (5) for attaching tool heads (12a, 12b, 13a, 13b) or bits (6) are arranged, where at least one key arm (2a, 2b) forms a pen-shaped, hollow handle (3), and the hollow handle (3) displays at least one opening (10, 11), through which at least one other key arm (2c, 2d) can be folded out and in. (FIG. 1)

The invention relates to a universal key, particularly a control cabinet key, with multiple key arms, on which tool heads and/or retainers for attaching tool heads or bits are arranged.

A universal key of this kind is known from German Utility Model 296 17 973 U1, for example. This universal key displays four key arms, arranged in the form of a cross. The tool heads of this universal key serve as locking tools for control cabinets. Control cabinets display locking elements that can, for example, be operated by means of a square, triangular or two-way key.

Persons involved in the installation or maintenance of control cabinets need a control cabinet key every day, meaning that they carry one with them at all times. A trouser or jacket pocket, such as is usually present on working clothes, suffices as the place for keeping a universal key of this kind.

Although a universal key fits in a jacket pocket, there is nonetheless a desire to further develop the known universal key and give it a more compact design for everyday use.

According to the invention, the object is solved in that at least one key arm forms a pen-shaped, hollow handle, and in that the hollow handle displays at least one opening, through which at least one other key arm can be folded out and in.

As a result of the movable connection of the key arms, the universal key can be collapsed into a pen-like structure having the appearance of a writing implement. The universal key according to the invention can advantageously be accommodated in a breast pocket, like a ballpoint pen. The universal key is favorably provided with a clip in the manner of a ballpoint pen. The clip fixes the universal key in place by firmly clamping it to the cloth. Handling of the universal key, i.e. its insertion into and removal from the pocket of a garment, is particularly simplified by the fact that the pen-like hollow handle displays no protruding key arms when in collapsed state.

The hollow handle can be turned like a screwdriver when in folded-in state. In this context, it is again of advantage that no laterally protruding key arms interfere with the turning movement. The hollow handle can be provided with a fixed screw-driving tool, or display a retainer for a bit or some other tool head.

The handling of the universal key is particularly good if both the hollow handle and the other key arm display a cylindrical cross-section, where the cylindrical outer surface of the key arm lies against the cylindrical inner surface of the hollow handle when in folded-in state. This results in the key arm being positively locked in the hollow handle.

To fold a key arm out of the hollow handle, this positive locking has to be overcome. The hollow handle is flexible to this end, and can be spread open elastically while folding out the key arm. The flexibility of the hollow handle can be determined by the choice of material and by the material thickness, such that a key arm can not only be folded out easily, but also displays sufficiently secure locking when folded in, and cannot fold out solely due to its own weight, for example.

The hollow handle can display a locking aid for securing the key arm in its folded-out position. The locking aid fixes the key arm in the optimum position for use.

The locking aid straightforwardly displays at least one transverse groove, formed in the wall of the cylindrical hollow handle. The transverse groove interacts with one end of the key arm. The axis of the key arm is aligned in the direction of the transverse groove.

The key arm is favorably enclosed between two opposite wall areas of the hollow handle, each opposite wall area displaying a transverse groove.

The transverse groove is advantageously of channel-shaped design and adapted to the outer surface of the key arm. This design results in exact fitting of the key arm in the transverse groove. To move the key arm from the folded-in position to the folded-out position, the hollow handle has to be spread open. Between the folded-in position and the folded-out position, a transitional edge has to be overcome that is formed between the transverse groove and the inner wall of the cylindrical hollow handle. This transitional edge is subject to wear as a result of the alternating inward and outward folding movements of the key arm. The wear can be reduced if, for example, the transitional edge is rounded off.

The possible uses of the universal key can be expanded if at least one key arm displays a turret element provided with several tool heads and/or retainers for alternative use.

The turret element is a rotating element, preferably displaying a lockable working position in which one of the tool heads or retainers can be fixed as required.

Straightforwardly, the key arm is of tubular design, one tube end of the key arm displaying two opposite holding tabs for the turret element, and a hinge pin for the turret element is mounted in the holding tabs.

The hollow, tubular design of the key arm creates space for accommodating the turret element. Provided alongside the holding tabs are recesses that create space for rotary movement of the turret element.

The universal key is particularly easy to handle if, in the working position of the turret element, a tool head and/or a retainer is enclosed by the holding tabs and locked in alignment with them, where the holding tabs can be spread elastically for rotation of the turret element. This design is very simple. The functional principle of locking the turret element in the key arm by means of elastic spreading of holding tabs of the key arm corresponds to the locking of the key arm, which can be locked in the hollow handle, since the locking of the key arm is likewise accomplished by elastic spreading, namely of the hollow handle when the key arm is moved from the folded-in position to the folded-out position, or vice versa.

A further advantage is achieved if the hollow handle displays an end with an end cap, and the end cap is provided with a carrier for an advertising logo.

The hollow handle is inexpensive and light if it is made of plastic.

A special design of the universal key provides for the hollow handle to integrate two key arms that are aligned with each other. In this embodiment, two further aligned key arms additionally form a one-piece cross-arm that can be folded out of the hollow handle and folded into the hollow handle. In this special embodiment, the universal key has the form of a key spider when in folded-out state. In this form, the universal key corresponds roughly to a customary control cabinet key with four key arms arranged in the shape of a cross.

The hollow handle of the universal key advantageously displays two openings, which are arranged in accordance with the direction of rotation of the cross-arm such that each end of the cross-arm can be folded out in one direction of rotation, and folded in in the opposite direction of rotation. In this embodiment, the cross-arm can only be folded out in one direction and folded in in one direction. The cross-arm cannot perform full rotation through 360°.

The cross-arm is preferably made of metal tubing.

Mounted in the hollow handle is a hinge pin, provided for the key arm(s) or for a cross-arm. The mounting point for the hinge pin must be designed in such a way that the hollow handle can be spread without the possibility of the hinge pin falling out of its mounting point. Furthermore, the hollow handle must display sufficient strength to transmit a torque when the universal key is used as a screw-driving tool. For this reason, the choice of the material for the hollow handle, and the wall thickness, are geared to the customary torques that have to be transmitted by the universal key.

An example of the invention is illustrated in a drawing below, and described in detail on the basis of several Figures. The Figures show the following:

FIG. 1: A perspective view of a universal key, with the key arms folded in,

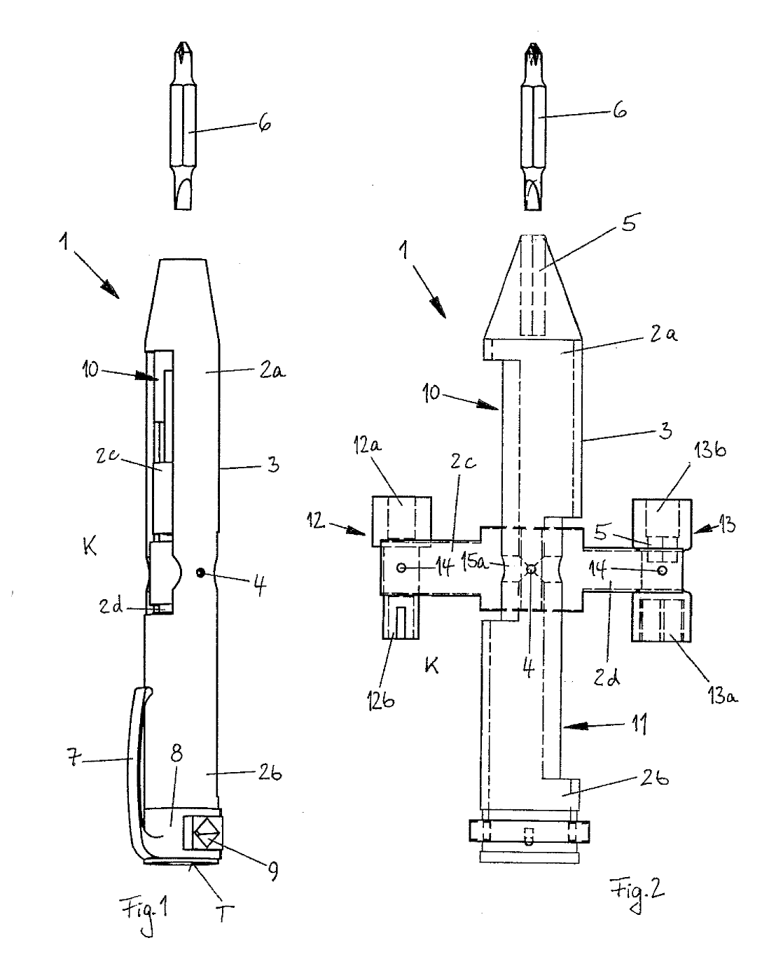

FIG. 2: A side view of the universal key according to FIG. 1, with the key arms folded out,

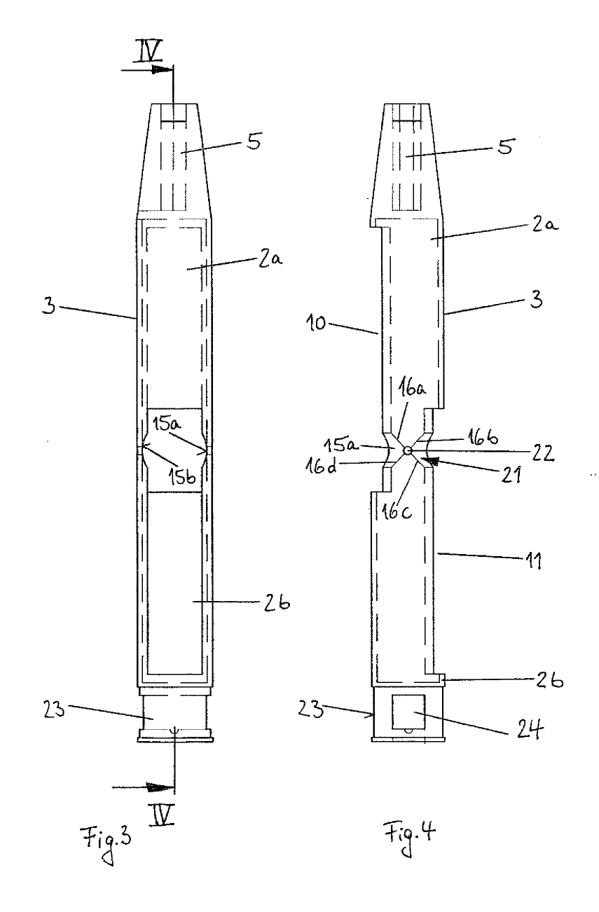

FIG. 3: A front view of a hollow handle,

FIG. 4: A side view of the hollow handle according to FIG. 3,

FIG. 5: An enlarged, perspective illustration of a cross-arm, with holding tabs for a turret element, and

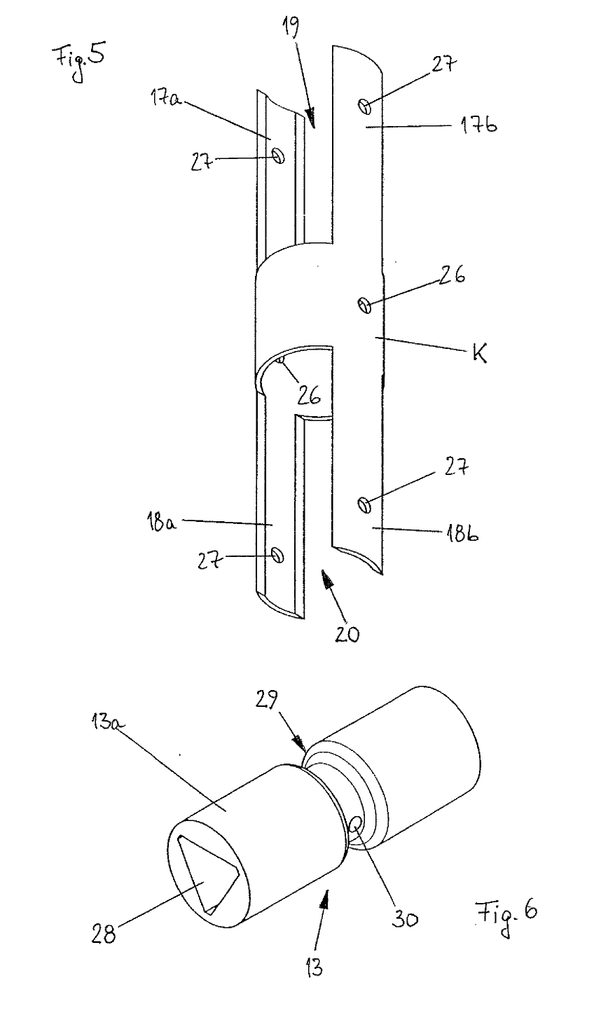

FIG. 6: An enlarged, perspective illustration of a turret element.

FIG. 1 of the drawing shows a universal key 1, which is designed as a control cabinet key. It displays tool heads on multiple key arms 2a, 2b, 2c and 2d, with which locking elements of control cabinets can be opened and closed. Locking elements for control cabinets can display different forms. Familiar examples include triangular, square, hexagonal, and two-way keys, or a key with the so-called Daimler-Benz form, which is roughly a negative of the key form of the two-way key.

According to FIG. 1, universal key 1 displays a pen-shaped, hollow handle 3, which unites two key arms 2a and 2b. Moreover, two key arms 2c and 2d are accommodated in hollow handle 3. A hinge pin 4 is mounted roughly in the middle of oblong, pen-shaped hollow handle 3. Key arms 2c and 2d, accommodated inside hollow handle 3, can be folded out of hollow handle 3 about this hinge pin 4.

A retainer 5 for a bit 6 is provided on the front end of hollow handle 3. Mounted on the rear end of hollow handle 3 is a clip 7, by means of which the universal key can be fastened to the pocket of a garment, for example, in the manner of a ballpoint pen.

Clip 7 is attached to an end cap 8, which is slid onto the rear end of hollow handle 3. End cap 8 is furthermore provided with a square 9 and forms a carrier T for an advertising logo. This square 9 is used for opening and closing radiator venting valves. It is arranged transverse to the longitudinal extension of hollow handle 3.

The folded-out position of key arms 2c and 2d is illustrated in FIG. 2. According to the drawing, the two key arms 2c and 2d are aligned with each other and of one-piece design. One-piece key arms 2c and 2d will be referred to as cross-arm K below. This is because, in folded-out position, they cross hollow handle 3 in the middle, and the universal key thus forms a key spider that corresponds to a known control cabinet key with key arms arranged in the form of a cross, both in terms of its dimensions and as regards its use.

It can be seen in FIG. 2 that hollow handle 3 displays an opening 10 or 11 for each of the key arms 2c and 2d of cross-arm K. In keeping with the direction of rotation of cross-arm K, openings 10 and 11 are located on opposite ends of hollow handle 3. Starting from the position shown in FIG. 2, cross-arm K has to be folded back in the opposite direction of rotation to fold it in. It is not possible to rotate cross-arm K farther in the folding-out direction.

Located on the free ends of cross-arm K are so-called turret elements 12 and 13, each of which displays two tool heads, 12a, 12b and 13a, 13b. A retainer 5 for a bit is integrated in tool head 13b.

The position of turret elements 12 and 13 shown in FIG. 2 is intended to illustrate that each of turret elements 12 and 13 can be rotated about a hinge pin 14. The illustrated position of turret elements 12 and 13 is not the position in which they are used. To position them for use, turret elements 12 and 13 must each be turned 90° farther or back in one or the other direction about hinge pin 14. Turret elements 12 and 13 are then aligned with cross-arm K and can be used in this position.

The present practical example of the universal key permits cross-arm K to be fixed in both the folded-in position and the folded-out position. Cross-arm K is described in more detail below on the basis of FIG. 5.

For fixing in the folded-in and folded-out position of cross-arm K, the invention exploits the round cross-section of tubular cross-arm K and the round cross-section of hollow handle 3.

The outside diameter of cross-arm K almost corresponds to the inside diameter of hollow handle 3. In folded-in state, cross-arm K is enclosed in hollow handle 3 in form-fitting fashion. Cross-arm K cannot be folded out of hollow handle 3 simply because the latter displays openings 10 and 11, but only because hollow handle 3 can be spread open to a certain degree. Without said spreading of hollow handle 3, cross-arm K would be retained in the hollow handle in form-fitting fashion. The possibility of spreading open hollow handle 3 permits folding movement and locking of cross-arm K.

So that the spreading of hollow handle 3 can again be elastically reversed in the position illustrated in FIG. 2, the inner side of hollow handle 3 is provided with transverse grooves 15a and 15b, which are likewise adapted to the round cross-section of cross-arm K. When folded out, cross-arm K is aligned with transverse grooves 15a and 15b. This causes reversal of the elastic spreading of hollow handle 3.

As a result of this design, transverse grooves 15a and 15b act as a locking aid in order to maintain the folded-out position of cross-arm K.

In this way, cross-arm K is enclosed by transverse grooves 15a and 15b on both sides in the area of the piercing point of hinge pin 4. Cross-arm K lies in short transverse groove 15a as in a channel, and is held in the aligned position. Transverse groove 15b acts in the same way. The situation is similar as regards the folded-in position of cross-arm K in hollow handle 3. Hollow handle 3 is likewise of channel-shaped design. The hollow handle holds cross-arm K in the aligned position. The design can be such that residual elastic spreading of hollow handle 3 generates an initial tension that forces cross-arm K into transverse grooves 15a and 15b.

The channel-shaped contours of transverse groove 15a and the inner wall of hollow handle 3 transition into each other in the area of hinge pin 4. This gives rise to transitional edges 16a, 16b, 16c and 16d. These transitional edges 16a, 16b, 16c and 16d have to be overcome in order to switch from the folded-in position to the folded-out position. The elastic spreading of hollow handle 3 occurs during this process. Since cross-arm K can only be folded out in one direction of rotation, and folded in in the opposite direction of rotation, only two of the four transitional edges are stressed, namely 16a and 16c. This is because cross-arm K only scrapes over these two transitional edges during the alternating inward and outward folding movements. The cross-arm moves away from the other two transitional edges, 16b and 16d, meaning that no wear occurs there.

The aligned position of turret elements 12 and 13 in the ends of cross-arm K is secured according to the same principle as the aligned, folded-in position of cross-arm K in hollow handle 3. Each turret element 12 or 13 displays tool heads 12a and 12b or 13a and 13b, the outside diameter of which corresponds to the inside diameter of tubular cross-arm K. When a turret element 12 or 13 is aligned with cross-arm K, the tool head of turret element 12 or 13 lies against the cylindrical inner surface of cross-arm K. Cross-arm K displays holding tabs 17a, 17b and 18a, 18b at its two ends, as well as recesses 19 and 20 between them. Recesses 19 and 20 create space for rotation of turret elements 12 and 13. To rotate turret element 12 or 13 out of the aligned position, holding tabs 17a, 17b, or 18a, 18b, have to be spread elastically. As soon as a tool head again moves into a position aligned with cross-arm K during rotation, spread holding tabs 17a, 17b, or 18a, 18b, again spring back and fix the position of turret head 12 or 13. In this context, residual elastic spreading can generate an initial tension that forces the turret elements between the holding tabs.

The design of hollow handle 3 is illustrated in FIGS. 3 and 4. Transverse grooves 15a and 15b, which are provided for fixing the folded-out position of cross-arm K in hollow handle 3, can be seen in FIG. 3. Transverse grooves 15a and 15b have a channel-shaped cross-section.

FIG. 4 shows a cross-sectional side view along the line indicated in FIG. 3. A hole 22 for accommodating hinge pin 4 for cross-arm K is shown in this view. Furthermore, transitional edges 16a, 16b, 16c and 16d can be seen in FIG. 4, resulting where the contour of transverse groove 15a transitions into the cylindrical inner wall of hollow handle 3. This results in the four transitional edges 16a, 16b, 16c and 16d, which form a diagonal cross 21 in FIG. 4. Located at the centre of diagonal cross 21 is a hole 22 for hinge pin 4.

Likewise clearly visible in FIG. 4 are openings 10 and 11 of hollow handle 3, which each extend into the area of transverse groove 15a. On the one side of hollow handle 3, opening 10 extends from transverse groove 15a towards the front end of hollow handle 3, while opposite opening 11 extends from transverse groove 15a towards the rear end of hollow handle 3. The rear end of hollow handle 3 is provided with a mounting area 23 for end cap 8. Mounting area 23 has a slightly smaller diameter than the remainder of hollow handle 3. Provided in mounting area 23 is a square hole 24, which penetrates mounting area 23 transverse to the longitudinal extension of hollow handle 3. Mounting area 23 and square hole 24 serve to accommodate end cap 8 which, according to FIG. 1, displays clip 7 and square 9, which is located in square hole 24 of mounting area 23. Square 9 is provided for operating radiator venting valves.

A loose cross-arm K is illustrated in enlarged form in FIG. 5. Cross-arm K is a tubular component, the two ends of which display holding tabs 17a, 17b and 18a, 18b, as well as recesses 19 and 20 provided between the holding tabs. In the middle of cross-arm K is a fully cylindrical area, in the wall of which two holes 26 are provided for accommodating one hinge pin 14 each. Holding tabs 17a, 17b and 18a, 18b likewise display holes 27 for hinge pins 14. As can best be seen in FIG. 2, turret elements 12 and 13 are mounted in rotating fashion by means of hinge pins 14 in holding tabs 17a, 17b and 18a, 18b.

A turret element 13 is shown in enlarged form in FIG. 6. Turret element 13 displays two tool heads 13a and 13b. One tool head 13a is provided with a triangular opening 28, which serves to operate a control cabinet locking element displaying an external triangle. A grooved area 29, displaying a transverse hole 30, can be seen in the middle of turret element 13. Transverse hole 30 serves to accommodate a hinge pin 14, the ends of which are mounted in holding tabs 18a and 18b of cross-arm K.

### LIST OF REFERENCE NUMBERS

1 Universal key
2a Key arm
2b Key arm
2c Key arm
2d Key arm
3 Hollow handle
4 Hinge pin
5 Retainer
6 Bit
7 Clip
8 End cap
9 Square
10 Opening
11 Opening
12 Turret element
12a Tool head
12b Tool head
13 Turret element
13a Tool head
13b Tool head
14 Hinge pin
15a Transverse groove
15b Transverse groove
16a Transitional edge
16b Transitional edge
16c Transitional edge
16d Transitional edge
17a Holding tab
17b Holding tab
18a Holding tab
18b Holding tab
19 Recess
20 Recess
21 Diagonal cross
22 Hole
23 Mounting area
24 Square hole
26 Hole
27 Hole
28 Triangular hole
29 Grooved area
30 Transverse hole
K Cross-arm
T Carrier

1. Universal key, particularly a control cabinet key, with multiple key arms, on which tool heads and/or retainers for attaching tool heads or bits are arranged, characterized in that at least one key arm forms a pen-shaped, hollow handle, and in that the hollow handle displays at least one opening, through which at least one other key arm can be folded out and in.

2. Universal key according to claim 1, characterized in that both the hollow handle and the other key arm display a cylindrical cross-section, where the cylindrical outer surface of the key arm lies against the cylindrical inner surface of the hollow handle when in folded-in state.

3. Universal key according to claim 1, characterized in that the hollow handle displays a locking aid for securing a key arm in its folded-out position.

4. Universal key according to claim 3, characterized in that the locking aid displays at least one transverse groove, formed in the wall of the cylindrical hollow handle.

5. Universal key according to claim 4, characterized in that the transverse groove is of channel-shaped design and adapted to the outer surface of the key arm.

6. Universal key according to claim 1, characterized in that at least one key arm displays a turret element provided with several tool heads and/or retainers for alternative use.

7. Universal key according to claim 6, characterized in that the key arm is of tubular design, one tube end of the key arm displaying two opposite holding tabs for the turret element, and in that a hinge pin for the turret element is mounted in the holding tabs.

8. Universal key according to claim 7, characterized in that, in the working position of the turret element a tool head and/or a retainer is enclosed by the holding tabs and locked in alignment with them, where the holding tabs can be spread elastically for rotation of the turret element.

9. Universal key according to claim 1, characterized in that the hollow handle displays an end with an end cap, and in that the end cap is provided with a carrier for an advertising logo.

10. Universal key according to claim 1, characterized in that the hollow handle is made of plastic.

11. Universal key according to claim 1, characterized in that the hollow handle integrates two key arms that are aligned with each other, and in that two further aligned key arms form a one-piece cross-arm that can be folded out of the hollow handle and folded into the hollow handle.

12. Universal key according to claim 11, characterized in that the hollow handle displays two openings, which are arranged in accordance with the direction of rotation of the cross-arm such that each end of the cross-arm can be folded out in one direction of rotation, and folded in in the opposite direction of rotation.

13. Universal key according to claim 1, characterized in that the cross-arm is made of metal tubing.
